(19) United States
(12) Patent Application Publication
(10) Pub. No.: US 2011/0028117 A1
(43) Pub. Date: Feb. 3, 2011

(54) Mobile Computing and Communication Device for Use as a Mobile Phone in Normal Operation and as a Survivability Detection Device in a Disaster Situation

(76) Inventor: Yang Pan, Shanghai (CN)

Correspondence Address: Yang Pan;Intellectual Power Pte Ltd, No. 14 Robinson Road #06-01,, Far East Finance Building, Singapore, 048545, SG

(21) Appl. No.: 12/534,108

(22) Filed: Aug. 1, 2009

(51) Int. Cl. H04M 11/04

(52) U.S. Cl. 455/404.1

(57) ABSTRACT

A mobile computing and communication device for a normal and an emergency occasion is disclosed. The invention is based upon a conventional mobile device with an added emergency operation unit including a second communication unit, a sensory unit and an external RF energy controlled switch. The second communication unit is based upon a short-range and ad hoc communication network. If the battery power is below a preset value, the mobile device is switched off. The reserved power is switched on for the emergency operation unit if a sufficient strong RF energy is received and a reference voltage in exceeding of a threshold voltage of a switch is generated. The radio-frequency energy may be delivered through an un-modulated electromagnetic wave from an external source. The second communication unit establishes the ad hoc communication network with a mobile rescues station and transmits the collected data from the sensory unit to the station through the network.

### CROSS-REFERENCE TO RELATED APPLICATIONS

This application is related to applications: 1) Ser. No. 12/344,519 and its division Ser. No. 12/508,511, and 2) Ser. No. 12/351,839.

### BACKGROUND

1. Field of Invention

This invention relates to a mobile computing and communication device, specifically to a mobile computing and communication device used for determining survivability and location of a trapped person under a disaster situation.

2. Description of Prior Art

A person may encounter many different dangerous situations during his or her life. For example, a person may be trapped under a mound of debris created by a fallen building during an earthquake or a terrorist attack. A rescue team is sent to fallen building to search for survivors. It is important for the rescue team to identify the location and status of the trapped person to save the person's life effectively. Although a mobile phone is becoming a popular handheld device, it may not be an effective communication device under a disaster situation. For example, the public telephone communication network may be destroyed during an earthquake. Further, a rescue task may take more than 1-2 weeks for a disaster such as an earthquake. The battery of the mobile phone may run out of power in a couple of days for most of devices.

Therefore, it is desirable to have a device based upon a mobile phone for locating a trapped person and for determining his or her survivability status under a disaster situation for a prolonged period of time after the incident. This allows a rescue team to have more opportunities to save a person's life.

### SUMMARY OF THE INVENTION

In an exemplary embodiment, a mobile phone is used to illustrate the inventive concept, which should not limit the scope of the present invention. The inventive concept can be extended to other mobile devices such as handheld media players, PDA (Personal Digital Assistant) and digital cameras. In one implementation, the mobile phone may further include second communication device such as a ZigBee transceiver. The ZigBee is a short range communication standard conforming to IEEE 802.15.4 and its amendments. The ZigBee device is operated under much lower power consumption than the mobile phone.

A mobile computing and communication device used in a disaster situation for a trapped person is disclosed in the present invention. A power management unit is used to measure the remaining power of a battery for the mobile phone. If the power is below a preset threshold value such as for example 10% of the maximum power, the mobile phone is switched off. The operation is almost transparent to a user of the mobile phone as long as the reserved power is a small portion of the battery power. The reserved power is used to supply the required power for an emergency operation unit comprising at least the second communication unit and a sensory unit for detecting the survivability of the trapped person. A ZigBee transceiver is taken as an exemplary illustration of the second communication unit. The ZigBee transceiver communicates with an external device through an ad hoc communication link or network. The reserved power is able to support the operation of the ZigBee device for a significantly longer period of time.

The present invention is characterized by that the mobile device is in the switched off status until receiving an external RF (radio-frequency) energy. The received RF energy is rectified to a DC (direct current) voltage. The DC voltage is further regulated to generate a reference voltage. If the reference voltage exceeds a threshold for a switch, the switch will connect the battery power to the emergency operation unit. The second communication unit, such as the ZigBee transceiver in the exemplary case, is the activated to connect to a nearby mobile rescue station through an ad hoc communication link or network. The mobile rescue station operates the RF power generator for providing sufficient energy to the device.

The switch further connects the battery power to an alert signal delivery unit and a sensory unit. The alert signal delivery unit delivers alerting signal (s) to the trapped person. According to one aspect of the present invention, the sensory unit is an accelerometer and/or a gyroscope. According to another aspect of the present invention, the alert signal delivery unit is a sound delivery unit. In a mobile phone case, the units mentioned above may have already been a part of the phone. After the alert delivery unit delivers a notable event of vibration of the device or a ring tone to the trapped person, the mobile device receives a signal from the accelerometer and/or the gyroscope if the person interacts with the device by touching or moving the device. The ZigBee transceiver then sends a data file, including data collected from the accelerometer and/or the gyroscope to the rescue station. In another embodiment of the sensory unit, an infrared sensor is used to detect infrared radiation induced by a human body. As for the alerting delivery unit, a light flashing device may also be employed either as an independent device or be employed with the sound/ring tone delivery unit.

The present invention distinguishes the prior art in that the mobile device will maintain at the switched-off status to reserve the battery power until the external RF energy is received. The RF energy creates a temporary power supply to switch on the reserved battery power.

The rescue station may decide the person's status by analyzing the received data file. The location of the trapped person may be determined by switching on a GPS device in the mobile phone. The location may also be determined by a zonal method related to the ad hoc network formed by a number of ZigBee devices. Disposable devices with ZigBee communication capability may be deposited at selected locations to form existing ZigBee nodes. The location of the trapped person with the mobile phone, including the ZigBee transceiver, may be determined based upon its relationship to the existing nodes. The method can be extended to a case of multiple persons and multiple rescue stations in a significant disaster situation.

### BRIEF DESCRIPTION OF THE DRAWINGS

For a more complete understanding of the present invention and its various embodiments, and the advantages thereof, reference is now made to the following description taken in conjunction with the accompanying drawings.

FIG. 1 is a schematic diagram of a mobile device illustrating the present invention.

FIG. 2 is a schematic diagram illustrating the functionalities of the power management unit and the RF controlled switch.

FIG. 3 is a schematic diagram of depicting functional blocks for converting a received RF energy into a reference voltage and for controlling the power connection to the emergency operation unit. A switch controller is used to maintain the connection after the RF energy power is withdrawn.

FIG. 4 is a schematic functional block diagram of one embodiment of the present invention based upon a mobile phone, a ZigBee transceiver and an accelerometer.

FIG. 5 is a schematic functional block diagram of the mobile device for use as the survivability detecting device that is used to collect the trapped person survivability status and to communicate with the external device.

FIG. 6 shows a schematic diagram that the mobile rescue station sends the RF energy to the mobile device and triggers the operation of the device as a survivability status detecting device.

FIG. 7 shows a flow diagram of depicting steps of the mobile device operations.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

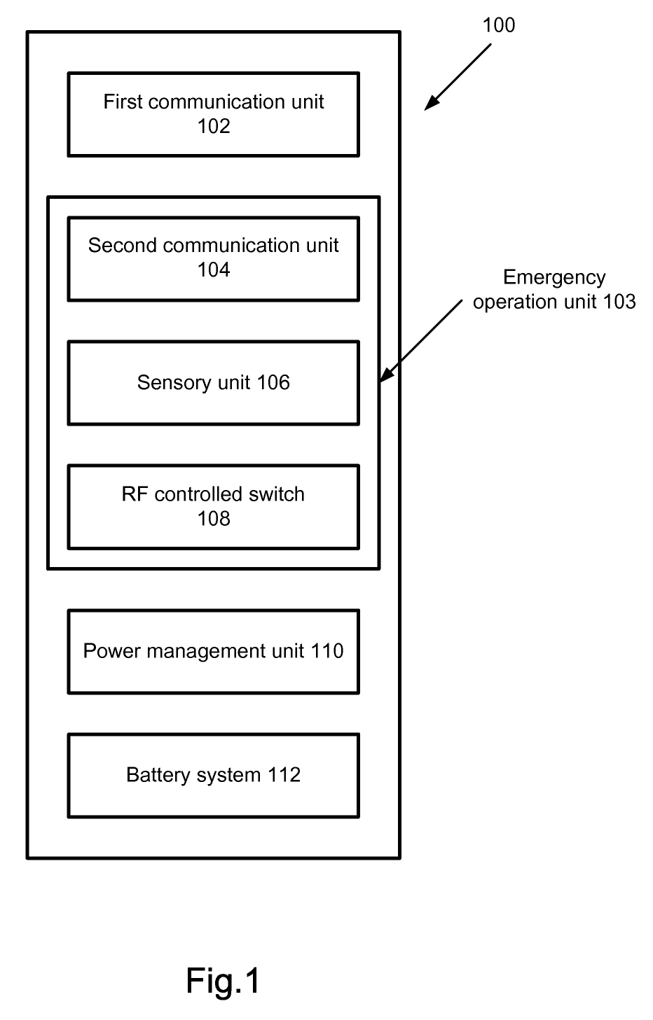

FIG. 1 is a schematic diagram of a mobile device 100 as an illustration of the present invention. The mobile device 100 includes a first communication unit 102. According to one implementation, 102 is a mobile phone except that a battery system is shown separately in the figure. The unit may conform to one of or a combination of the existing mobile phone communication standards such as, for example GSM, CDMA and 3G of a public telephone network. The mobile device 100 further includes a second communication unit 104. In accordance with one implementation, 104 is a short range communication device. It may form an ad hoc communication network with other similar devices. The short range communication device consumes typically much less power than a mobile phone.

The mobile device 100 further includes a sensory unit 106. The sensory unit 106 is an accelerometer and/or a gyroscope in one embodiment. The sensory unit 106 may be an infrared sensor in another embodiment. The sensory unit 106 may be a voice receiver unit of the mobile phone and be used to record a voice signal induced by the trapped person in yet another embodiment.

The invention is characterized by that a RF controlled switch 108 is used to enable a “switching-on” operation from the battery power to the second communication unit 104. The “switching-on” operation is activated by receiving the RF energy generated from an external source and by subsequently converting the received energy into a reference voltage in exceeding of the threshold voltage of the switch. The RF energy may be delivered by an un-modulated electromagnetic wave. This is in distinct difference with a conventional RFID system, where the RF signals delivered from a reader to a tag are modulated.

The second communication unit 104, the sensory unit 106 and the RF controlled switch 108 form an emergency operation unit 103. A power management unit 110 is used to control the power flow in the mobile device 100. A battery system 112 is also included. The battery system 112 may be a rechargeable battery. The battery system 112 may also be a main battery and an auxiliary battery. The power management unit 110 measures the remaining battery power in a predetermined frequency such as after every 5 minutes of operation and switches off the power supply for the first communication unit when the measured power is below a preset value. The preset value may be determined by the system provider and be adjusted by the user of the mobile device. A predetermined value at 10% of the maximum power, for example, will not cause significant inconvenience for the user of the mobile device 100 when it is used as a mobile phone. When the battery system 112 includes the main battery and the auxiliary battery, the main battery is used to enable the operations of the first communication unit 102. The auxiliary battery is used for supplying power for the second communication unit 104 after the main battery runs out of the power. In such a two-battery implementation, both batteries are charged during a battery charging operation. Further, the auxiliary battery may not be removable from the mobile device.

If a trapped person switches off the mobile device 100 proactively, the reserved power for the emergency operation unit 103 may exceed the preset value. In the main/auxiliary battery system, it means that the reserved power may exceed the auxiliary battery power.

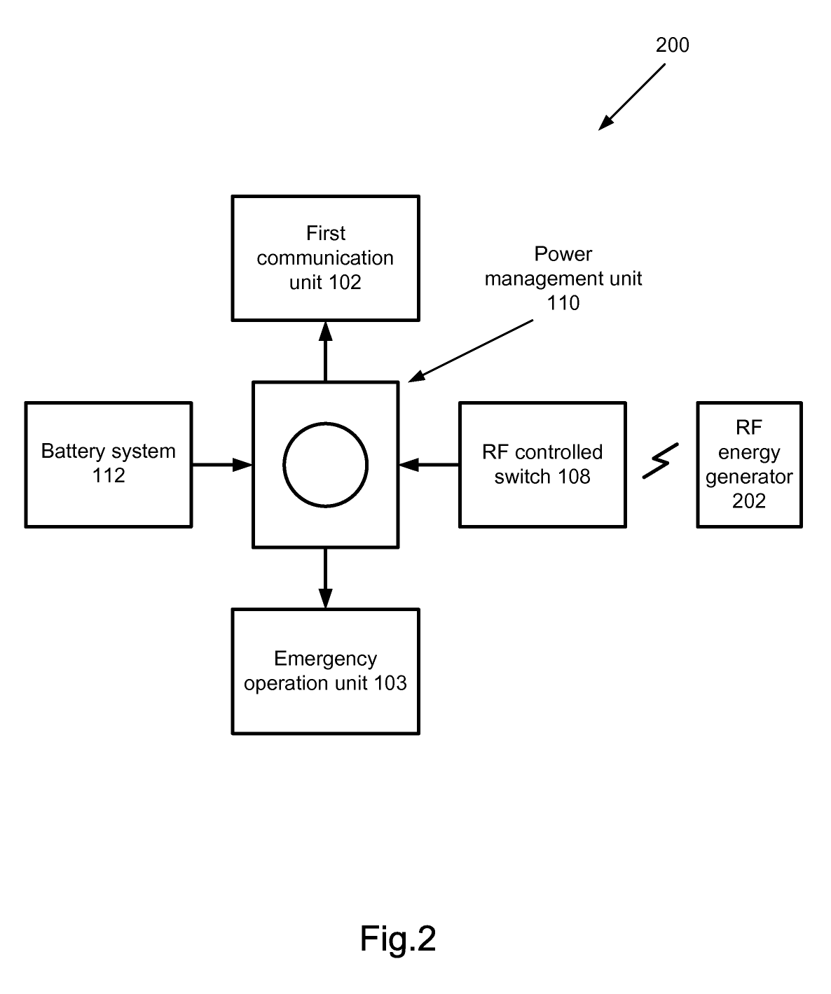

The operation of the power management unit 110 of the mobile device 100 is illustrated in FIG. 2. The power management unit 110 is used to control the power flow in the device. In a normal operation as a mobile phone, the power management unit 110 directs the power from the battery system 112 to the first communication unit 102. If the measured remaining power of the battery system 112 is below the preset value, the power management unit 110 switches off the battery power and the device is powered off. After an external RF energy generator 202 delivers the energy to the device 100, the RF controlled switch 108 receives the energy and converts the received energy into a DC reference voltage. If the reference voltage is in exceeding of the threshold of the switch, the power management unit 110 directs the remaining power in the battery system 112 to the emergency operation unit 103. The unit 103 has the functionality of sustaining its operation by drawing a DC current component from the battery system 112 to maintain the reference voltage at a level which is sufficient for the switch maintaining at “on” state even after the external RF energy generator 202 is switched off.

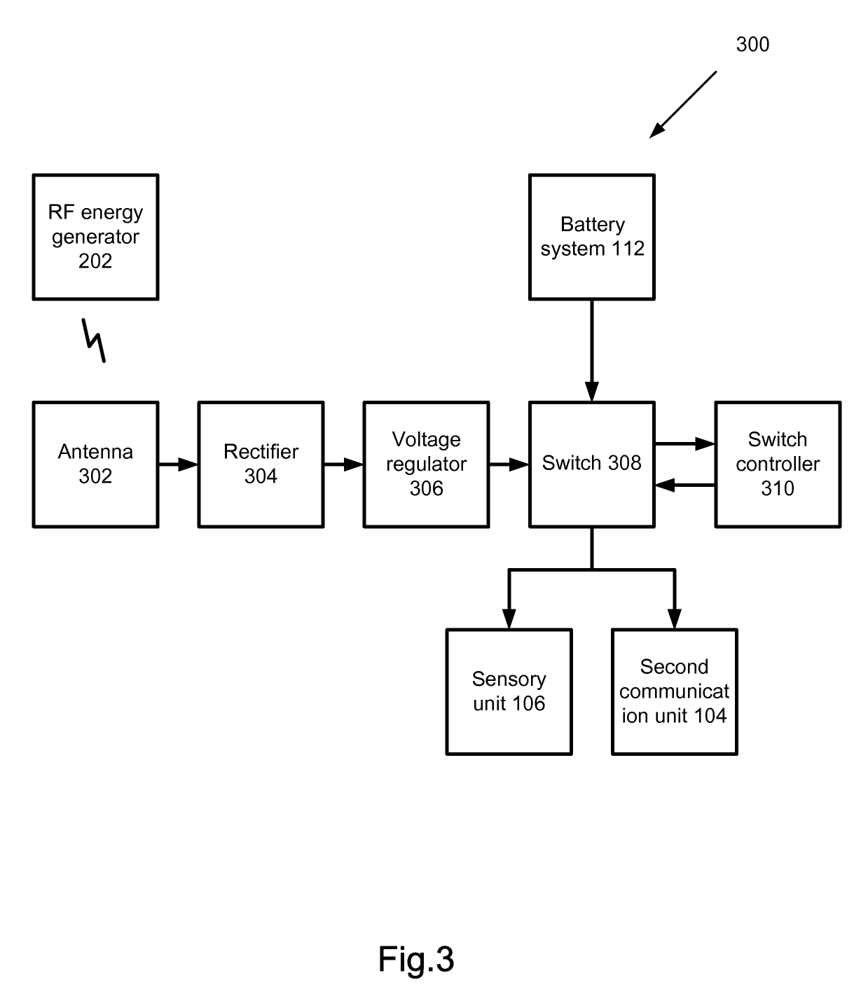

As shown in FIG. 3, the RF controlled switch 108 further comprises an antenna 302, a rectifier 304, a voltage regulator 306 and a switch 308. The antenna 302 may be of inductive type or be of a dipole type depending on the frequency of the RF energy. The high frequency RF energy requires a dipole type of antenna. The rectifier 304 converts at least a portion of the received RF energy into a DC component. The voltage regulator 306 converts the DC component into a reference voltage. The reference voltage turns on the switch 308 if the voltage is in exceeding of its “on” threshold. A switch controller 310 is used to ensure the switch 308 to maintain at the “on” state after the RF energy is withdrawn. In one implementation, the controller 310 may draw a current from the power supply to assist to charge up an output capacitor of the voltage regulator 306 after the switch 308 is switched on. After the external RF energy source 202 is switched off, the voltage regulator 306 ceases to provide a stable output voltage. However, the current source controlled by the controller 310 will provide a current source and a stable voltage to maintain the switch at “on” state.

When a mobile rescue station equipped with an RF energy generator and a communication device attempts to locate a trapped person, it sends out the RF power in the incident area. After receiving the RF power by the RF controlled switch 108 and a reference voltage in exceeding of the threshold value may be reached, the second communication unit 104 and the sensory unit 106 are subsequently switched on. Further, according to one embodiment of the present invention, an event of notable vibrations and/or a ring tone are delivered to the trapped person through the mobile device 100. The interaction or non-interaction of the person with the mobile device 100 results in signals collected by the sensory unit 106. The second communication unit 104 sends the collected signals to the mobile rescue station. The user's location may be determined by a GPS (Global Positioning System, not shown in FIG. 1). The user's location may also be derived based upon a zonal method of the ad hock network. It should be noted that although a single source of RF energy generator is used to illustrate the present invention, multiple RF energy generators may be employed in the incident area. The RF generators may be deployed to different locations to increase the coverage in order that all mobile devices receive the sufficient RF energy and switches the device on for detecting survivability status of the trapped persons.

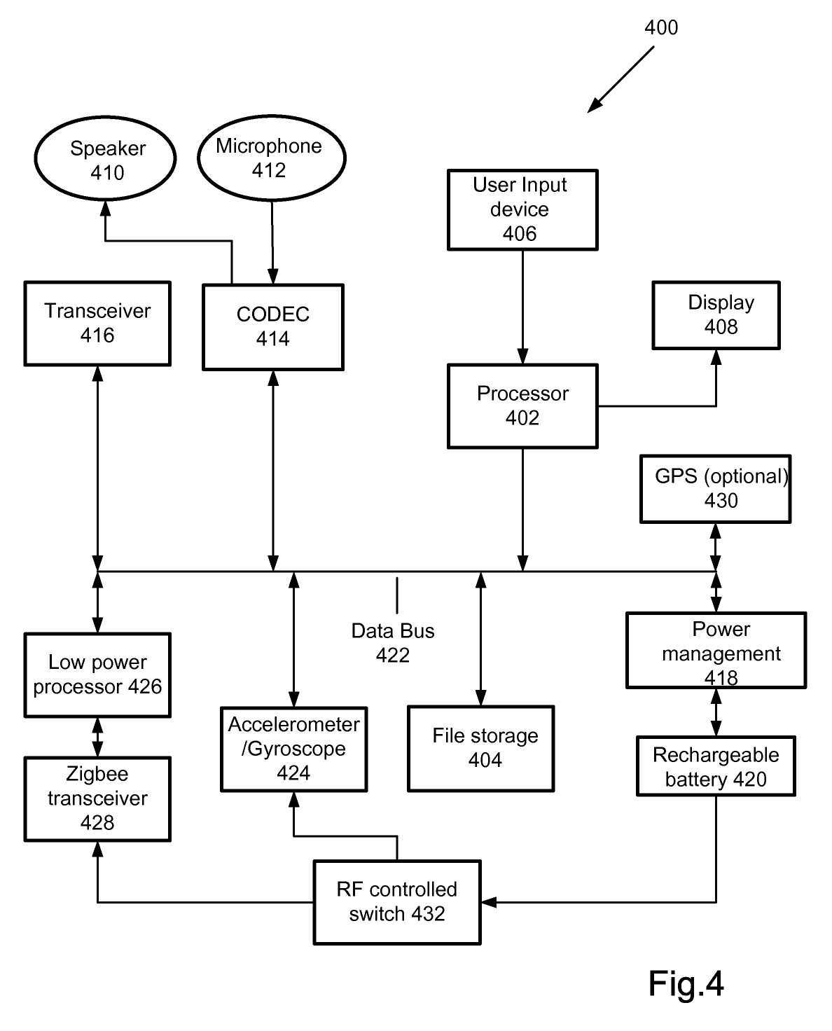

An exemplary illustration of the mobile device is shown in FIG. 4. The mobile device may be in an integrated form contained in a single case. The device 400 includes a processor 402 that pertains to a microprocessor or a controller for controlling the overall operation of the mobile device 400. The processor may also include a DSP (Digital Signal Processor). The file storage system 404 is, typically, a flash memory or a plurality of flash memories. The file system 404 may also include a cache, for example, a Random-Access Memory (RAM) provided by semiconductor memory. The relative access time to the cache is substantially shorter than for the flash memories. The mobile device 400 also includes a user input device 406 that allows a user to interact with the device. For example, the user input device 406 can take a variety of forms, such as a button, keypad, dial, etc. The mobile device 400 includes a display 408 (e.g., Liquid Crystal Display) that can be controlled by the processor 402 to display information to the user. The mobile device 400 also includes a speaker 410 and a microphone 412 both are connected to a coder/decoder (CODEC) 414. The CODEC 414 converts digital signals into analog ones for the speaker. It also serves function to receive the analog signals from the microphone and converts to digital signals for further processing by the processor 402.

The mobile device 400 further includes a transceiver 416 for transmitting and receiving signals and for communicating with an external device through an existing communication network. The network may be based upon GPS, CDMA, 3G and any other existing wireless communication standard of a public telephone network. The mobile device is powered by a rechargeable battery system 420 through a power management unit 418. The various units may be connected to a data bus 422. A sensory unit is an accelerometer and or a gyroscope 424 in a preferred embodiment. Silicon based accelerometer and or gyroscope has been used in mobile device to enhance its functionality such as in iPhone from Apple Inc.

In another embodiment of the sensory unit, 424 may be an infrared sensor, which may be used to detect body temperature of a nearby human body and to determine the survival status of the trapped person. In yet another implementation, the microphone 412 may be used to receive voice message from the user and 424 may be eliminated or may be in use with 412 in a combination.

The mobile device 400 includes the second communication unit that is taken as a ZigBee transceiver 428 as an exemplary case as shown in the figure. A low power processor 426 may be added in the configuration to manage the device operation after the first communication unit and main portion of the device are switched off. ZigBee is the name of a specification for a suite high level communication protocols using small, low-power digital radios based on the IEEE 802.15.4 standard for wireless personal area network (WPANs). The technology is intended to be simpler and less expensive than other WPANs, such as Bluetooth (IEEE 802.11b). ZigBee is targeted at radio frequency (RF) applications that require a low data rate, long battery life, and secure networking.

The mobile device 400 may also include a GPS unit 430 as an option to determine the location of the trapped person. Alternatively, the location can be determined by a zonal method for an ad hoc network formed by multiple ZigBee devices. In the present invention, a RF controlled switch 432 is used to control the power supply from battery 420 to the ZigBee transceiver 428 and the accelerometer 424.

When the device 400 is operated as a conventional mobile phone, the battery power is delivered to supply the required power for the phone operation. 426/428 for the second communication unit 104 is switched off. The power management unit 418 is used to monitor remaining power of the battery 420. If the battery power is below a preset value, the mobile phone is switched off.

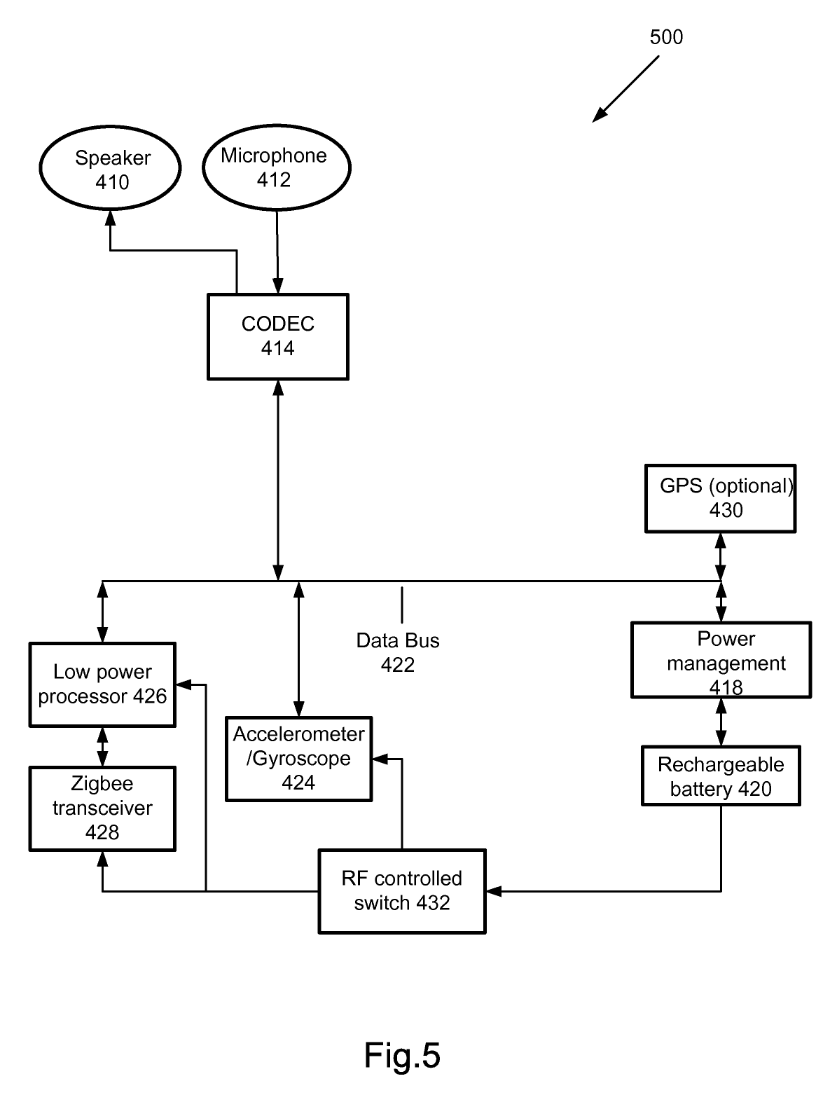

After the arrival of the mobile rescue station in the incident area, the associated RF energy generator 202 is switched on. If the received RF energy generates a sufficient high reference voltage, the processor 426, the transceiver 428 and the accelerometer 424 are then switched on with a power supplied from the battery 420 as shown in FIG. 5. Although a low power processor 426 is explicitly shown in the figures, it may not be a separate unit. It may be the processor 402 operating at low power mode. It may also be in a single chip integration form with the ZigBee transceiver 428.

In the subsequently operations, the low power processor 426 switches on the accelerometer 424, the GPS 430 (optional) and the voice processing blocks (410, 412 and 414). The GPS unit 430 is not required if the location of the trapped person is determined by the zonal method. Further, the voice processing block may also not be essential in the operation illustrated by the device 500. After the processor 426 sends a command, the mobile device will deliver vibration signals or a ring tone to the trapped person. The accelerometer 424 receives a signal if the person touches or moves the device after notifying the alert signals. The collected signals will be sent back to the mobile rescue station for analyzing the status of the person. In the same time, the personal identity and/or other personal data may also be read out and be sent to the rescue station. The personal data may be stored in a memory in the same chip as the Zigbee transceiver. It may also be stored in the file storage system of the mobile device. Before the data file including personal information is transmitted to an external source, an authenticity process may be needed to verify the source. The authenticity method and process is known in the art.

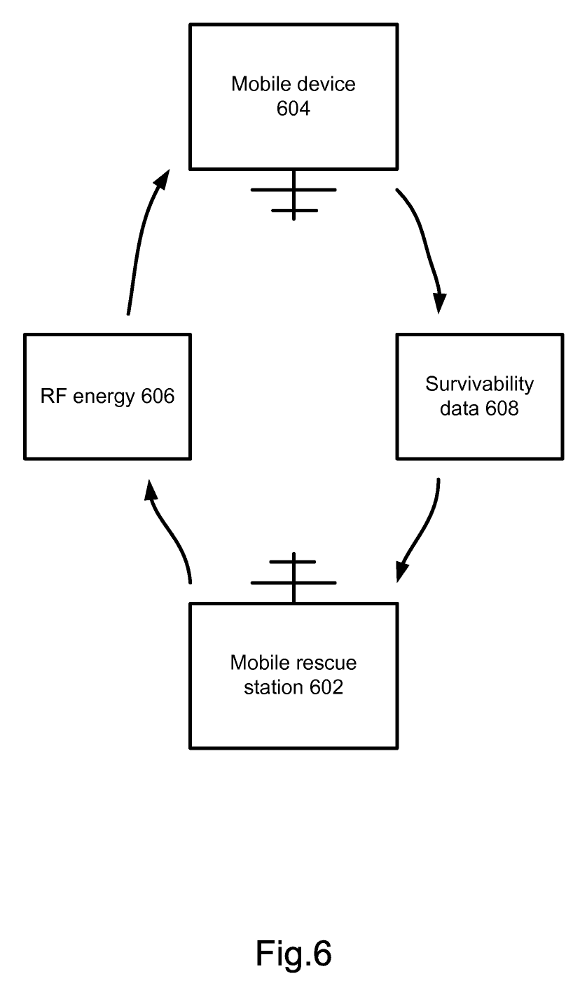

The interaction between the mobile rescue station 602 and the mobile device 604 is further illustrated in FIG. 6. The mobile rescue station 602 sends the RF energy 606 to the mobile device 604. The mobile device 604 then sends back a file 608 to the rescue station 602 which may comprise the person's identity, the person's survival status represented by the signals collected from the sensory unit 106 and the location detected from the GPS (optional). Although one rescue station and one mobile device are shown in the figure, the inventive concept can be extended to multiple mobile devices and multiple rescue stations. In the case that the zonal method is used to determine the person's location, multiple disposable communication devices including ZigBee transceivers may be used to form existing nodes of the ad hoc network. Locations of trapped persons associated with the respective Zigbee device may be determined based upon their relationship with the existing nodes.

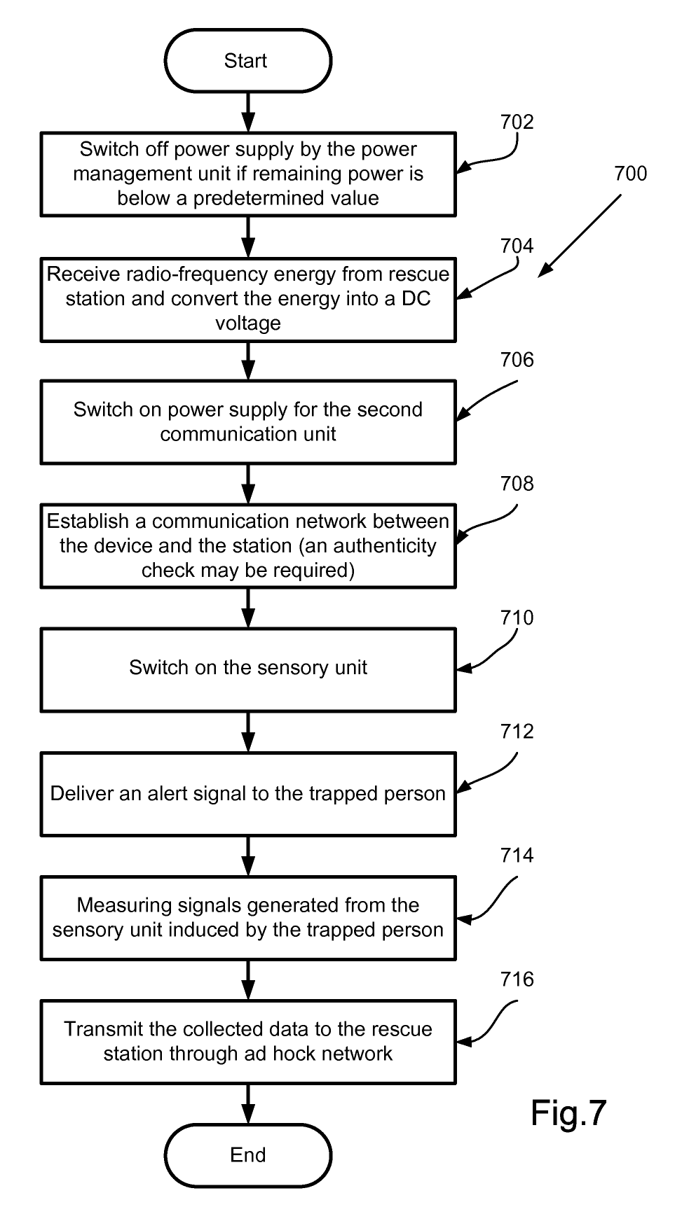

FIG. 7 shows a flow diagram for process 700 that depicts the operation of the mobile device 100. The process 700 begins with a step 702 that the battery power is switched off after the remaining power of the battery system 112 measured by the power management unit 110 is below a preset value. The device 100 is in the switch-off mode after the step 702. In step 704, the RF energy generated by the external RF generator associated with the mobile rescue station is received by the device and is converted into a DC voltage. If the DC voltage is in exceeding of the threshold of the switch 308, the second communication unit 104 is switched on in step 706. A communication link or network is established in step 708. The authenticity of the external communication device may be checked before any data transmission is allowed. In step 710, the sensory unit 106 is switched on. An alerting signal including a sound signal, a ring tone and/or a vibration event of the device 100 is delivered to the user through the device in step 712. The sensory unit, in step 714, collects data induced by the trapped person. In one embodiment of the sensory unit, an accelerometer and/or a gyroscope is used to detect the motion of the device induced by touching or moving the device by the person after notifying the alert signal. In another embodiment of the sensory unit, an infrared sensor is used to detect infrared radiation generated by the trapped person. In yet another embodiment, the voice processing and delivery unit of the mobile phone is switched on and the sound signals generated by the trapped person are recorded. The collected data is then transmitted to the rescue station through the established ad hoc network. Other data associated with the person's identity may be pre-stored in the device. The stored data may be read out and be transmitted together with the collected survivability data.

While the invention has been disclosed with respect to a limited number of embodiments, numerous modifications and variations will be appreciated by those skilled in the art. The mobile phones have been used as the exemplary cases in the disclosure. The inventive concept can be extended to PDA'S, media players, digital cameras and laptop computers for one skillful in the art. It is intended that all such variations and modifications fall within the scope of the following claims:

1. A mobile computing and communication device powered by a battery system, the device comprising:
(a) a first communication unit providing a means for communicating with another communication device through a public telephone network;
(b) a second communication unit providing a means for communicating with another communication device through an ad hoc communication network after said first communication unit is powered off;
(c) a power management unit comprising a means of power reserving capability and a means for switching on the reserved battery power for said second communication unit triggered by an external radio-frequency energy;
(d) a sensory unit for detecting survivability of the trapped person,
whereby said device is used at least as a mobile phone in a normal operation and is used as a survivability detecting device for a trapped person after a disaster event to maximize the opportunity of the person to be rescued.

2. The device as recited in claim 1, wherein said external radio-frequency energy is delivered from an external apparatus to the device by an un-modulated electromagnetic wave.

3. The device as recited in claim 1, wherein said means of power reserving capability is provided by measuring the remaining power of the battery system and by switching off said device if the measured power is below a predetermined value.

4. The device as recited in claim 1, wherein said battery system comprising a main battery and an auxiliary battery and the auxiliary battery power is reserved for the emergency use.

5. The device as recited in claim 1, wherein said means of switching further comprising a radio-frequency energy receiver, a rectifier and a voltage regulator, wherein the “switching-on” operation is triggered after the output of the voltage regulator exceeding a threshold value.

6. The device as recited in claim 1, wherein said device further including:
a GPS (Global Positioning System) for determining the location of said device.

7. The device as recited in claim 1, wherein the second communication unit comprising a short range communication device, for providing said ad hoc communication means, conforming to a standard or a combination of standards from the following group:
ZigBee (IEEE 802.15.4 and its amendments);
Bluetooth (IEEE 802.11b and its amendments); and
WiFi (IEEE 802.11 and its amendments).

8. The device as recited in claim 1, wherein said sensory unit further comprising an accelerometer and/or a gyroscope which is used to detect a motion induced by a trapped person.

9. The device as recited in claim 1, wherein said sensory unit further comprising an infrared sensor for detecting an infrared radiation induced by the trapped person.

10. The device as recited in claim 1, wherein said device further comprising an alert signal delivery unit including a voice signal processing unit, a voice signal delivering unit, and/or a vibration signal delivering unit and/or a flashing light.

11. A method of communication between a mobile computing and communication device associated with a trapped person and a mobile rescue station associated with a rescue team, wherein the mobile device comprising a first communication unit for communicating through a public telephone network, a second communication unit for communicating through an ad hoc communication network, a power management unit including an external radio-frequency energy controlled switch, a battery system and a sensory unit, the method comprising the steps of:
(a) switching off the power supply from the battery system to said first communication unit by said power management unit;
(b) receiving radio-frequency energy from the rescue station and converting received energy into a voltage by said switch;
(c) switching on the power supply from the battery system to support the operation of said second communication unit if said voltage is in exceeding of a threshold value;
(d) establishing a communication link between the device and the mobile rescue station.

12. The method as recited in claim 11, further comprising the steps of:
(e) switching on the sensory unit for detecting the survivability status of the trapped person;
(f) delivering an alert signal including an event of notable vibrations and/or a ring tone;
(g) measuring signals generated from the sensory unit induced by the trapped person; and
(h) transmitting collected data to the mobile rescue station.

13. The method as recited in claim 11, wherein said method further comprising verifying the authenticity of the rescue station before the communication network is established.

14. The method as recited in claim 11, wherein said second communication unit comprising a short range communication device conforming to a standard or a combination of standards from the following group:
ZigBee (IEEE 802.15.4 and its amendments);
Bluetooth (IEEE 802.11b and its amendments); and
WiFi (IEEE 802.11n and its amendments).

15. The method as recited in claim 11, wherein said mobile rescue station comprising a radio-frequency electromagnetic wave generator that delivers said radio-frequency energy to trigger the switching operation of said switch.

16. The method as recited in claim 11, wherein the mobile rescue station comprising a communication device at least conforming to the same communication standard (s) as the second communication unit of the mobile device.

17. The method as recited in claim 11, wherein said sensory unit further comprising an accelerometer and/or a gyroscope and/or an infrared sensor for detecting an interaction between the trapped person and said mobile device.

18. The method as recited in claim 11, wherein said device further comprising a voice signal processor for detecting voice signals induced by the trapped person.

19. A device for switching an electrical connection by an external radio-frequency energy, the device comprising:
(a) An antenna pertaining to receive external radio-frequency energy;
(b) a rectifier for converting received radio-frequency energy into a direct-current electrical component;
(c) a voltage regulator for converting said electrical component into a voltage;
(d) an electrical switch with a threshold controlled by said voltage; and
(e) a means for maintaining the electrical connection after the radio-frequency energy is withdrawn.

20. The device as recited in claim 19, wherein said means for maintaining electronic connection is provided by another unit which draws electrical current from the battery to maintain a switching-on status of said switch.
